(19) United States
(12) Patent Application Publication
(10) Pub. No.: US 2007/0192259 A1
(43) Pub. Date: Aug. 16, 2007

(54) BRANDING CONVEYANCE SYSTEMS, METHODS AND ARTICLES OF MANUFACTURE

(76) Inventor: Keith Rockhill, Baltimore, MD (US)

Correspondence Address: NIXON & VANDERHYE, PC, 901 NORTH GLEBE ROAD, 11TH FLOOR, ARLINGTON, VA, 22203, US

(21) Appl. No.: 11/623,438

(22) Filed: Jan. 16, 2007

Related U.S. Application Data
(60) Provisional application No. 60/759,079, filed on Jan. 17, 2006.

(51) Int. Cl. G06Q 10/00

(52) U.S. Cl. 705/408

(57) ABSTRACT

Methods and apparatus for constructing and using a print advertising and branding conveyance device (PABCS), and means of use.

### CROSS-REFERENCE TO RELATED APPLICATIONS

The present application claims priority under 35 U.S.C. 119(e) from U.S. Provisional Patent Application No. 60/759,079 filed on Jan. 17, 2006, the entire disclosure of which is incorporated herein by reference for all purposes.

### COPYRIGHT NOTICE

A portion of the disclosure of this patent document can contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2006-2007, Brandserts, LLC.

### FIELD

The technology herein generally relates to a persistent, print advertising and branding conveyance system (PABCS) which improves the persistence of print advertising targeted to consumers and the methods of use of PABCS's in useful ways.

### BACKGROUND

There is often confusion between the concepts of brand, advertising or ads. Brand is the proprietary visual, emotional, rational, and cultural image associated with a company or a product. The purpose of having people remember the brand name and have positive associations with that brand is to make their product selection easier and enhance the value and satisfaction they get from the product, while an advertisement is a public promotion or inducement to buy a specific product or service. Most prior techniques that include advertisements include ads that are strictly an inducement to buy, generally characterized by offers to sell specific products for a specified price, coupons, or other calls to action designed to motivate a consumer to make a purchase of good or services. Brand promotion promotes and furthers a proprietary visual, emotional, rational, and cultural image associated with a company or a product and generally does not include a call to action for the consumer.

Print advertising and brand awareness effectiveness is measured in the number of times an individual or group of individuals view the advertising and branding materials. In most cases, an individual views a particular print advertisement once as they page through a book, magazine, trade or professional journal, and like publications. Each of these viewings is commonly referred to as an “impression”. Advertising rates from publishers to advertisers are typically set based upon the number of expected impressions. A variety of schemes have been used to increase the probability that an individual actually views a particular advertisement, but the nature of the medium lends itself to a single impression per reader. Some studies have shown that the longer a brand message is kept in front of a consumer, the better the chance that a consumer will remember the brand message and not the branding of a competitor. Other studies have shown that repetition of advertising improves response rates, so advertisers often saturate their target markets with advertisements in order to achieve a repetition of impressions. The competing saturation advertising produces a sea of advertising clutter as whole that ends up reducing recognition and recall of individual advertising and branding messages.

Furthermore, it is not uncommon for a person reading or perusing books, magazines, professional or trade journals, and so on, to note an item of interest to purchase at a later date and/or to remove special offers or coupons from a publication and wish to “store” these items for later use. Existing techniques provide bound-in, tear out advertisements which permit a reader to detach and take a copy of the advertisement with them if the reader has an express interest in the advertised materials. Other techniques designed to create a call to action or facilitating expression of interest have also been tried, such as blow-in advertising return cards. Each of these techniques suffer in that they do not provide a way to persistently move each advertiser's message into the life of the reader and keep the message there, turning a single impression into a repeated series of impressions.

Many attempts have been made to produce satisfactory branding results. For example, branded trinkets, such as ink pens, post-it note pads, and the like, have existed for many years and are a staple of traditional brand awareness. Some trinkets, such are ink pens, are useful, but are both costly to produce and distribute, and are often unable to be distributed using print media because of their bulkiness.

Print-based approaches exist which provide advertising-centric devices including advertising and an integrated pouch in which to store coupons. Some such approaches include for example a pre-printed grocery list. These devices, and similar devices in the art, focus on being vehicles for advertising instead of brand. The mishmash of messages created by several disparate advertisements confuses the consumer and reduces the consumer's desire to use the devices described in the above patents. Each of these prior techniques also lacks a means for ensuring their association with one or more delivery medium effective to ensure their initial delivery and conveyance to a user.

Other prior approaches provide for example bookmarks with notes fields that may be detached from a bound publication and used within the publication. Some such techniques provide removable bookmark and notepad combinations. These devices, and similar devices in the art, focus on functional aspects and do not provide for communication of brand and advertising away from the original publication.

While much work has been done in the past, there is a need to overcome these and other drawbacks associated with conventional print advertisement methods and devices and to provide a mechanism and embodiments of devices that convey advertising and branding messages to readers in formats that both provide persistence of message and that are cost effective to produce and distribute.

### SUMMARY

In general, in one aspect, an exemplary illustrative non-limiting implementation provides an article of manufacture for extending the reach of branding impressions beyond a first delivery medium. In some implementations, the article may comprise for example a first portion, attachable to the delivery medium and comprising one or more branding indicia, effective for conveying the branding, and a second portion, detachable from the delivery medium, further comprising at least one branding indicia and at least one user functional feature, which are effective to induce the user to detach and use the detachable portion for at least one purpose that is substantially unrelated to the first delivery medium.

In another aspect, the exemplary illustrative non-limiting implementation provides a device for extending the reach of branding impressions beyond a first delivery medium. In some implementations, the device may for example comprise: a first portion, detachable from the delivery medium, comprising one or more branding indicia and at least one user functional features, which are effective to induce the user to detach and use the detachable portion for purposes unrelated to the first delivery medium, the portion being attached to the delivery medium using one of a tie or band.

In another aspect, the exemplary illustrative non-limiting implementation provides an article of manufacture. The exemplary illustrative non-limiting article of manufacture may comprise for example: an item for delivery to a user; at least one portion that is easily user-detachable from the delivery item, the detachable portion providing a space for a user to write a list and may further provide at least one brand indication; and further means for inducing the user to detach the detachable portion from the delivery item and transport the detachable portion to a point of sale associated with the brand indication.

A still further exemplary illustrative implementation may provide for example a method of using a PABCS device. An exemplary illustrative non-limiting method may comprise for example associating each of a sequence of PABCS devices with at least one of a sequence of periodical publications, and providing the ability for a brand owner to sponsor one or more PABCS devices.

A PABCS causes a breakthrough in the realm of advertising in that they provide an additional “dimension” to branding over conventional means. An aspect of this new dimension is what allows the results to be a significant improvement of delivering the brand message over conventional pages and inserts.

This new dimension is the PABCS's ability to give a benefit outside of advertising or branding, that is each PABCS can provide a potential value to each specific end user that is/can be independent of any direct benefit to promoting the advertiser. This utility value could even be value of entertainment through a puzzle or cartoon. This is new and different from most all conventional advertising today that is 100% directly self serving to the advertiser or brander.

Additionally, each PABCS allows each specific potential user to become a “thought leader” within their own sphere of influence. They allow each user to initially and continually reach themselves and others in their circle with the brand information. As an improvement over conventional ads or inserts, PABCSs are specifically designed to facilitate this dynamic rather than being just something that one “rips out” of a publication to show someone else.

This user can then become a “champion” of the brand or product or simply a “host” of the brand or product to serve in conveying the message to someone who is interested and will take action. An example of this is the housewife who uses the off-road truck branded PABCS and eventually her husband or son act on the brand and that the user is interested in something about, both of which the husband or son might never have seen if she didn't pass it on to them in a shopping trip list, or a gift, or with notes on something in a magazine. Thus, the PABCS enables the brand to “travel” outside the conveying periodical.

The exemplary illustrative non-limiting implementations can provide one or more of the following advantages. The methods and devices in accordance with various embodiments of the exemplary illustrative non-limiting implementation convey advertising and branding messages to readers in formats that provide persistence of message. The advertising and branding messages are cost effective to produce and distribute. Branded impressions are delivered in conjunction with functional features desirable to users. This delivery, coupled with detachable portions of the PABCS, provide a persistent branding experience that occurs even beyond the initial method of delivery. The functionality or the method can be independent of the brand. The details of one or more embodiments of the exemplary illustrative non-limiting implementation are set forth in the accompanying drawings and the description below. Other features and advantages of the exemplary illustrative non-limiting implementation will be apparent from the description and drawings, and from the claims.

### DESCRIPTION OF DRAWINGS

FIG. 1A shows a schematic of an exemplary Shop-n-List shopping organizer using PABCS technologies in accordance with one embodiment of the exemplary illustrative non-limiting implementation.

FIG. 1B shows an exemplary Shop-n-List shopping organizer.

FIG. 2 shows an example embodiment of a Shop-n-List layout with a plurality of custom die-cut shaped removable portions in accordance with one embodiment of the exemplary illustrative non-limiting implementation.

FIG. 3 shows a Door Hanger embodiment of a PABCS layout in accordance with one embodiment of the exemplary illustrative non-limiting implementation.

FIGS. 4A-4D shows an example embodiments of Tag Shop-n-List PABCS layout in accordance with one embodiment of the exemplary illustrative non-limiting implementation.

FIG. 5 shows a CardSert PABCS layout in accordance with one embodiment of the exemplary illustrative non-limiting implementation.

Like reference symbols in the various drawings indicate like elements.

### DETAILED DESCRIPTION

Description of Some Exemplary Illustrative Non-limiting Implementations

A print advertising and branding conveyance system (PABCS) may include a combination of zero or more attachment features, one or more artistic features, which can include zero or more advertising/branding features or indicia, and one or more functional features desirable to a consumer or reader.

Each of the features or combination of features is designed to be useful to a consumer or reader (collectively referred to herein as a user) to the point that the user finds it sufficiently convenient to use the feature(s) and is willing to use one or more aspects of an exemplary illustrative non-limiting “PABCS” approach to gain access to the feature or combination of features. Collectively, PABCS provides assembling a print advertising and branding conveyance effective to present advertising and branding opportunities to users in a persistent form where the branding materials are regularly visible to the user while the user employs one or more features of the PABCS, thereby increasing the reach, recency, and dwell time of the brand experienced by the user. Furthermore, portions of a PABCS can be removed by a user. These user removable portions can be effective to extend the reach and life of the advertising and branding materials embodied within each PABCS by making the materials visible over a longer duration of time and to other users who are not the original consumer or reader of the PABCS. This ability to provide increased awareness, coupled with the eye-catching branding design characteristics of a preferred embodiment of a PABCS, provides a significant improvement in the effectiveness of the PABCS over traditional advertising materials, even when these materials are combined with functional elements desired by users.

Focusing on branding makes it possible to produce PABCSs that are associated with a specific brand or combination of brands and that are retained by users based on a combination of functionality and brand loyalty. This is in contrast to the prior art advertising-centric models, which typically produce devices along functional lines and plaster the devices with disparate advertising. In some embodiments, the production of PABCSs can be sponsored by a specific brand owner during a specific time period. For example, a PABCS can be created that conveys the image, logo and shapes appropriate for a local baseball sports team, and that includes team-specific branding indicia, such as the team logo and mascot. In addition, the PABCS can be shaped in a form that makes the PABCS eye-catching, while maintaining consistency with the specific branding image. In the above sport team example, the PABCS can be shaped, for example, as a baseball or a baseball field diamond. Other shapes of a PABCS can be used in manners that are consistent with specific brand desires.

A PABCS can be assembled using a variety of materials effective to both convey the advertising and branding messages desired and to meet the functional requirements of the feature(s) incorporated within the PABCS. In many embodiments, a PABCS is constructed using paper products of appropriate thickness (for example, paper weight), strength, color, and optionally with one or more coatings. Differences in paper weight and strength can be used to produce the desired visual, tactile, and overall effects, as well as to achieve functional aspects of specific features. Preferably, a premium quality paper is used in the construction of a PABCS to facilitate conveyance of a premium brand impression and to improve durability of one or more features of a PABCS. Several different paper products having differing weights, strengths, or colors can be combined when producing a PABCS. Coatings can be used to improve the appearance or functional characteristics of at least one aspect of a PABCS and can cover part of or the entire PABCS. Different parts of a PABCS can have different coatings, and in some embodiments, several coatings can be used on specific PABCS features. Some of the coatings can be scented. Other materials can be used to construct portions of a PABCS, such as plastics and polymers. For example, one or more portions of a PABCS can be constructed using a sheet of plastic, such as PVC, a spun polymer sheet, such as Tyvec, or a clear plastic film, such as acetate or a polycarbonate. Other materials, such as metal and metal foils, can also be used as appropriate within the branding image. For example, using a lightweight sheet metal or metal foil in an exemplary PABCS for a branded soda. Still other examples of materials usable in a PABCS can include fabrics constructed using various materials and techniques. Different portions of a PABCS can be constructed with differing materials and coatings appropriate to their intended use, or in accordance with the desired branding or desired visual effects.

Different portions of a PABCS can be assembled using one or more of various methods well known to those skilled in the art, including folding, tab-and-slots, pressure/heat-based techniques, and adhesives of various types. Similarly, different portions of the PABCS can be die cut, punched, or shaped in ways that enhance the overall branding effect. In some embodiments, stickers or decals can be affixed to one or more portions of a PABCS. Some examples of non-standard shapes are shown in the detailed examples below.

An overall goal of the shaping and construction of each aspect PABCS is to produce a device that delivers one or more desired brand impressions to a user along with one or more functionality features that extend the brand reach beyond the basic delivery medium. The delivery of the branded impressions in conjunction with functional features desirable to users, coupled with detachable portions of the PABCS, provide a persistent branding experience that occurs even beyond the initial method of delivery.

In some embodiments, one or more portions of the PABCS can be detached, for example, “tear off’ portions that include one or more features that the user desires to retain or use. In alternative embodiments, there can be several “tear off” portions of a single PABCS. The tear off portions serve to extend the reach of the PACBS device's branding message and are effective at keeping a branding or advertising message in front of users for an extended period of time, dramatically improving the users' recall and awareness of the branding or advertising message.

Association with Carrier or Delivery Medium

The optional attachment features of a PABCS include those portions of a PABCS effective to associate the PABCS with a physical carrier or delivery mechanism. The association can be permanent or temporary and serves to make the PABCS available to a user through one or more established delivery media.

A PABCS can be associated with a delivery medium in a persistent or non-persistent manner. Common means of associating a PABCS include the traditional print processes of binding a PABCS within a book, magazine, trade journal, professional journal, catalog, and the like publication in which several pages are secured together at the spine edges of the pages. In some embodiments, the PABCS can be “bound in,” that is, perfect bound or saddle stitched, tipped in, blown in, or bound in using other binding methods that are well known to those skilled in the arts.

Portions of the PABCS can be detached by a user to carry the branding message, while leaving other portions of the PABCS within the publication for later readers. One exemplary attachment means includes binding of a PABCS within a book, magazine, periodical, catalog, or other bound print media in such a manner as to permit one or more portions of a PABCS to be removed by a user in order to facilitate the further distribution and persistence of the branding associated with the PABCS.

Other means of associating a PABCS with a delivery medium can be less permanent than binding within a publication. Non-permanent means of associating a PABCS with a delivery medium facilitates the delivery of PABCSs using delivery media other than printed publications. Alternatively, the non-permanent association means can facilitate the removal of the PABCS from the delivery medium in order to further the goals of extending the reach and life of the advertising and branding materials embodied within the PABCS, by making the materials visible to users who are not the original consumers or readers of the PABCS.

In still further embodiments, a PABCS can include an attachment means by which some or all of the PABCS is attached to the delivery medium using an adhesive. The adhesive can be selected from adhesives well known in the art based upon attributes of the adhesive and the materials to which the adhesive is bonding to (for example, the material of the delivery medium and the material of the PABCS). In one embodiment, a PABCS can be adhered to a delivery medium using permanent adhesive and the PABCS can be constructed so that the portions adhered to the delivery medium permit the “tear off” removal of the remainder of the PABCS. This configuration enables the remainder of the PABCS to be removed by a user in order to facilitate the persistence of the advertising and branding by a “tear off” portion of the PABCS that the users desire to retain.

In other embodiments, a removable adhesive, such as the removable adhesive used in Post-It notes, can be used to adhere a PABCS to a delivery medium. Alternatively, a PABCS can be removably adhered to the delivery medium using a two-layer peel-away means, such as known in the art for providing peel-off coupons.

In all, there are several mechanisms for associating a PABCS with a delivery medium. The association mechanisms to be used are preferably chosen by the PABCS creator considering the overall branding effect to be presented by a PABCS. In some embodiments, a PABCS design can also simultaneously incorporate several association mechanisms to permit a single PABCS design to be associated with multiple delivery media. For example, a single PABCS design can be bound into a first periodical, and the same PABCS design can be associated with a product using an adhesive.

In some embodiments, the attachment means include mechanisms for attaching a PABCS to the delivery medium with a tie or elastic band. The tie or band attachment means can be optionally configured with a perforation to enable a portion of the PABCS to be removed from the delivery medium by a user in order to facilitate the persistence of the advertising and branding by a “tear off” portion of the PABCS that a user desires to retain.

Further examples of attachment means include the function of a door knob handle, operable to cause a PABCS to be attached to a door knob. The door knob hanger means can be optionally configured with a perforation to enable the remainder of the PABCS to be removed by a user in order to facilitate the persistence of the advertising and branding by a “tear off” portion of the PABCS that the users desire to retain.

Other alternative embodiments of attachment means can include magnetic means, and can include the construction of part of a PABCS using magnetic materials. Alternatively, at least one portion of a PABCS can be a magnet.

Artistic/Branding Features

A PABCS can further include one or more artistic features, operable to advance the brand communication characteristics of a PABCS. These features can include one or more aspects such as colorings, textures, artistic images, shapes and attachments effective to communicate the branding effect desired by a creator or sponsor. The artistic areas are generally composed of artwork and images selected by the creator of the PABCS with intent to further or promote branding or effect consumer opinion.

For example, one or more artistic features can include shaping at least part of the PABCS as a recognizable brand. For example, a portion of a PABCS can be shaped in the form of brand recognizable item, such as the “Nexium® purple pill” or the Viagra® blue triangle”. In the “purple pill” example, a PABCS can have an oval shape and the artistic areas colored purple. In alternative embodiments, die cut portions of the PABCS can be used to create PABCS portions having holes that further the desired branding or interactivity features of the PABCS.

In some embodiments, more than one brand can be presented within a single PABCS. For example, effective PABCSs can be constructed where a first portion presents a first brand of a sponsor and a second portion presents a second brand of a sponsor. The first and second portions can be related in various ways, for example, they can be separate tear off portions, front and back of a PABCS, or can be layered so that the removal of a first portion of the PABCS reveals the second portion. These techniques provide a mechanism by which a PABCS can present co-branded or complementary brands in a unified manner.

In some embodiments, a PABCS includes zero or more advertising areas, each of which provide one or more advertisements. Advertising areas can include most forms of traditional print advertisements, company contact information such as a company name, address, telephone number(s), web address, or other information. Care must be taken to ensure that the use of advertising areas does not detract from the brand effect provided by the PABCS.

PABCS Features

A PABCS further includes zero or more additional feature areas, each including one or more design options intended to engage the user by providing functional aspects to the device. Feature areas provide user desirable features that entice a user to detach and use a portion of a PABCS, thus taking at least part of the advertising and branding materials along with them. The construction and use of each of these features are well understood in the art. Some examples of such feature areas include:
Note grid—an area where a user can make their own notes. Some examples of note grids include: a to-do list, a note list, a shopping list, a TV program guide, movie guides, web site lists, telephone numbers, and so on.
Pocket—to store and carry receipts, coupons, rebates, recipes, and so on.
Envelope—same functionality as the pocket, but can be more securely sealed to protect the contents.
Machine readable coding, such as a barcode or RFID tag.
Coupons or coupon books.
Scratch-and-win cards.
Contest pieces.
Rewritable areas (for example, re-mark-able area).
Gift card holder, with or without Gift card.
CD/DVD holder, with or without CD/DVD.
Premium holder, with or without premium.
Product sachets.
Content, such as recipes, facts, tips, or other information of value to the user.
Games or puzzles, such as a SuDoKu or crossword puzzles

Other design options are intended to be removed from the device by the user. Design options are either removed along with a portion of the device, for example, a coupon, or are attached to and removed from the device, for example, a gift card. In some embodiments, the design options may be encapsulated or contained within a PABCS, such as contained between two parts of a PABCS. In some exemplary embodiments, the two parts of a PABCS are a part bound to the delivery media and a removable part. Some exemplary design options include:
Coupons and/or product information, such as a single perforated takeaway piece, a multi-fold, accordion fold, gate fold, or booklet piece that is separate and affixed to a PABCS.
Rubber or plastic magnets.
Perfume, cologne, or air freshener scents.
Gift, club, phone, and collectible cards.
Product samples, packs or sachets.
Stickers.
Temporary tattoos.
CDs and DVDs.
other

In various embodiments, design options can be attached by the following means:
Adhesive (temporary or permanent), for example, gift card, stickers, and so on.
Sleeve or pocket affixed to the Shop-n-List, for example, gift card, mini CD ROM or DVD, and so on.
Sleeve or pocket created using the entire page, for example, full size CD ROM or DVD.
Incorporated with a “belly band” or similar product.
other
   Methods of Use/Purpose

Each PABCS produces a line of functional brand communication devices effective to deliver a brand message and then move a branding message beyond the delivery medium and into the user's life. The unique functionality drives users to spend more time with the advertisement/branding, delivers greater exposure, stronger impact, and greater return on investment.

A primary purpose of a PABCS is to provide means for extending and enhancing the delivery of brand images and awareness to consumers by transforming a typical one-time impression of a brand image into a persistent experience across a single or several users, including those not directly exposed to the delivery medium with which the PABCS is provided. Each PABCS provides features and shaping effective to facilitate the engagement of a user. These features, which are brand-specific, help break through the clutter of advertisements and competing brand messages present in most delivery media. The interactive utility of the PABCS greatly increases the chances of effectively reaching the user and the advertising/branding message provided as part of the PABCS being remembered by the user.

The exemplary illustrative non-limiting PABCS is capable of producing user recognition and recollection. A PABCS in a periodical insertions can result for example in over 90% of the readers indicating that the tested PABCS rated as “good” or “excellent” and over 50% indicating that they would be “very likely” to detach and use the detachable, functional portions of the PABCS. Almost 50% might indicate that the PABCS made a “strong” or “very strong” impression on them. Exemplary illustrative non-limiting sample PABCSs could for example provide that more than 60% of readers recall seeing the PABCS. Such results would provide effectiveness of the combination of features provided by a PABCS over traditional advertising and branding methods.

In furtherance of this purpose, an exemplary use of PABCSs includes providing a series of PABCSs to users in association with a specific delivery medium, such as a specific monthly periodical. Readers of the periodical receive a branded PABCS with each issue of the periodical. Each monthly issue of the periodical has an associated specific configuration of a PABCS, so users become familiar with the presence of the PABCS and its user-desirable features. The persistent brand distribution platform afforded by the regular insertion of a PABCS into a specific periodical provides a sponsorship mechanism by which different issues of the periodical can be sponsored by an organization looking to spread their branding message with high effectiveness, with the PABCS effecting improved brand recognition and recall over other forms of advertising.

Sponsors of PABCSs in this delivery model can include traditional advertisers, as well as branded organizations interested in establishing goodwill to members. For example, a charitable organization such as the American Red Cross can sponsor a PABCS in a periodical in order to engender goodwill or to promote a specific program such as a charitable contribution drive, and include within their PABCS a detachable pledge envelope and signup sheet. The PABCS improves recall and follow through to PABCS sponsors by keeping their brand message in front of users for an extended time.

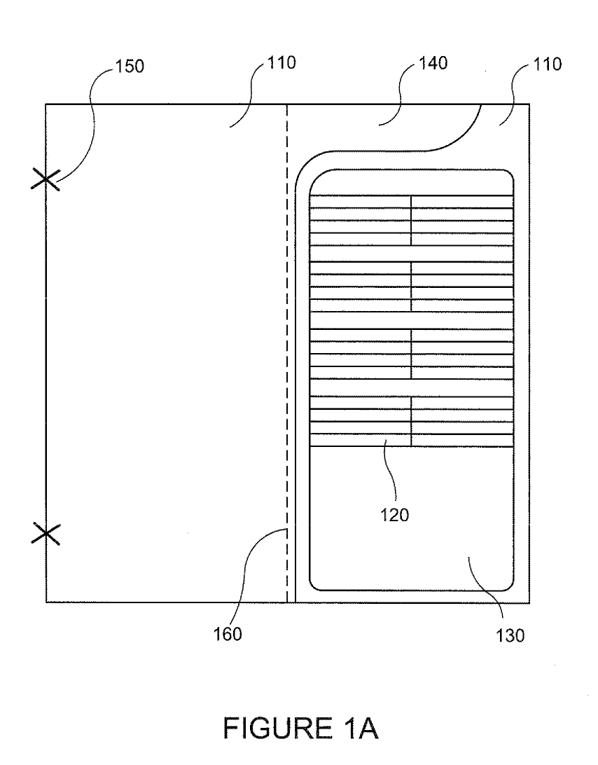

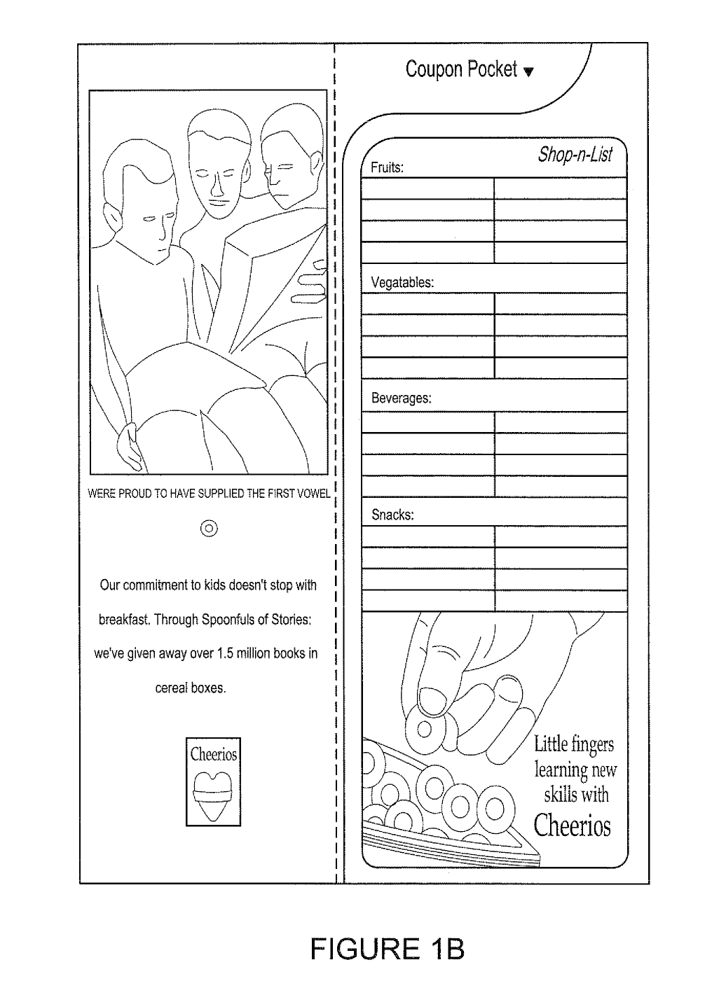

FIG. 1A shows an exemplary schematic of a Shop-n-List PABCS, which demonstrates an exemplary use of an exemplary illustrative non-limiting implementation of a PABCS. The Shop-n-List PABCS provides the functionality of a shopping organizer (that is, shopping list with a coupon storage pocket) and page combination, which includes branding features (110), a note grid (120), advertisement and branding spaces (130), a pocket or envelope feature (140) and an attachment mechanism (150) by which the Shop-n-List is affixed to a periodical publication. The example Shop-n-List PABCS includes a scoring or perforation (160) by which a portion of the Shop-n-List can be removed from the periodical publication by a reader in order to use the functionality of the pocket and note grid features outside of the periodical. The portion of the Shop-n-List PABCS left in the periodical continues to convey the branded image, as does the removable portion of the Shop-n-List PABCS.

The basic proportions of the Shop-n-List are that of a typical publication page or smaller, but can vary in size and shape in accordance with creator or sponsor preference. In the described exemplary embodiment, a Shop-n-List version of the PABCS is sized to fit on the front section of a periodical publication and can be attached to the periodical using a permanent or removable adhesive. Alternatively, the Shop-n-List can be bound into the periodical as described above.

As can be seen in FIG. 1A and in sample embodiment FIG. 1B, the Shop-n-List includes a designated area specifically intended for the end-user to make notes (120), referred to herein as a NoteGrid, and a designated area specifically intended for advertising or additional branding. In some embodiments, the advertising may be replaced with additional branding materials. The NoteGrid can be designed and targeted to a variety of specific uses, such as grocery, electronics, health & beauty, depending upon the type of publication to which the Shop-n-List is affixed. The NoteGrid can be designed in a variety of ways, as can be envisioned by those of ordinary skill in the art. Branding materials used within the Shop-n-List include the combinations of color, shape, texture, and content that is effective to convey a branded image or user impression. The Shop-n-List also includes a die cut pocket (140), referred to herein as a Coupon Pocket, intended to store coupons, special offers, additional notes, or any other item deemed appropriate by the end-user. As the skilled reader realizes, there are several alternate embodiments of a Shop-n-List. Some of these embodiments will now be described below.

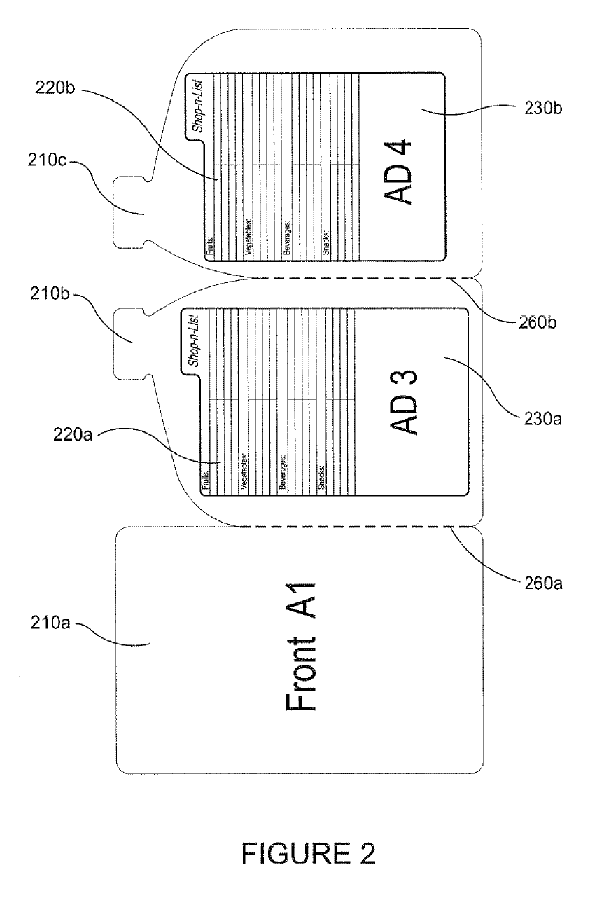

FIG. 2 shows a schematic of an alternative embodiment of a Shop-n-List layout in accordance with one embodiment of the exemplary illustrative non-limiting implementation. This example embodiment Shop-n-List comprises a plurality of Shop-n-List user detachable features, die-cut shapings, and other features as described above. The Shop-n-List PABCS provides branding features (210a, 210b, 210c) which include die-cut portions in the shape of a milk or detergent bottle that further reinforce the brand associated with device, a plurality of note grids (220a, 220b), advertisement and branding spaces (230a, 230b), and an attachment mechanism (not shown) by which the Shop-n-List is associated with the delivery medium, e.g. a periodical publication. The example Shop-n-List PABCS includes a plurality of perforations (260a, 260b) by which portions of the Shop-n-List can be removed from the periodical publication by a reader in order to use the functionality of the note grid features outside of the periodical. Each portion of the Shop-n-List PABCS left in the periodical continues to convey the branded image, as does each removable portion of the Shop-n-List PABCS.

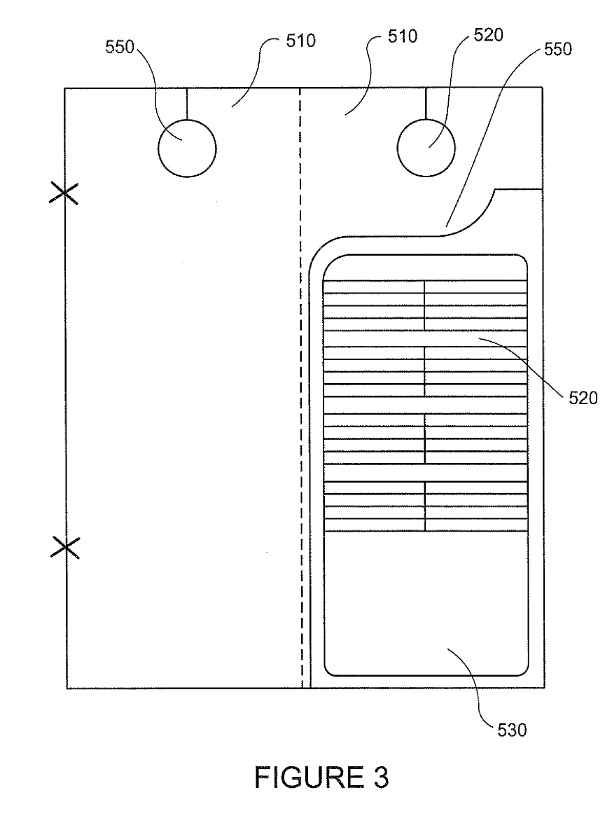

FIG. 3 shows a schematic of a PABCS embodiment incorporating a die cut door hanger layout in accordance with one embodiment of the exemplary illustrative non-limiting implementation. The Door Hanger embodiment includes all the elements of the PABCS, including branding features (510), a note grid (520), advertisement and branding spaces (530), a pocket or envelope feature (540) and incorporates a die cut attachment method for use in the distributing the piece on doorknobs (550). Example uses of this format of Shop-n-List may include uses within hotels in which the portion of the PABCS The example PABCS includes a perforation by which a portion of the PABCS can be removed from the hanging portion by a user in order to use the functionality of the pocket and note grid features away from the door. The portion of the Shop-n-List PABCS left on the door continues to convey the branded image, as does the removable portion of the Shop-n-List PABCS.

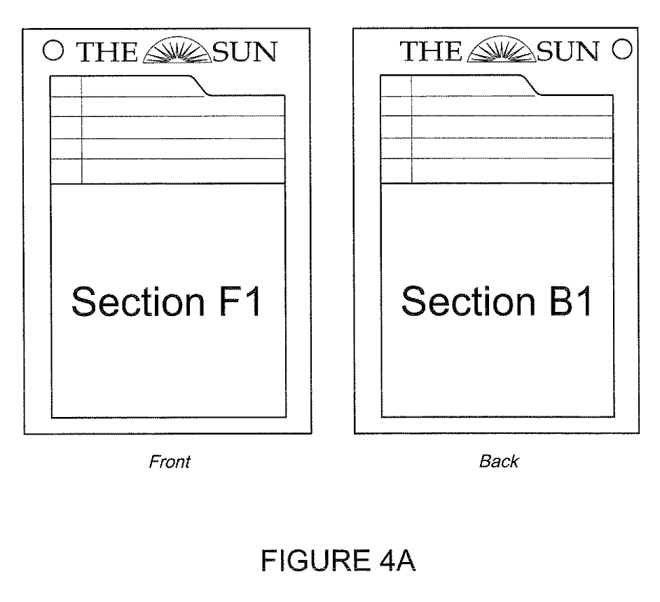

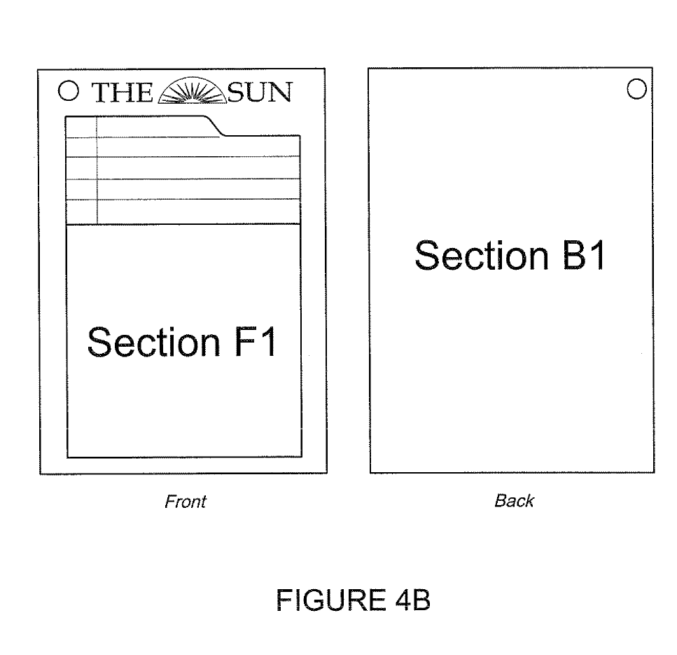

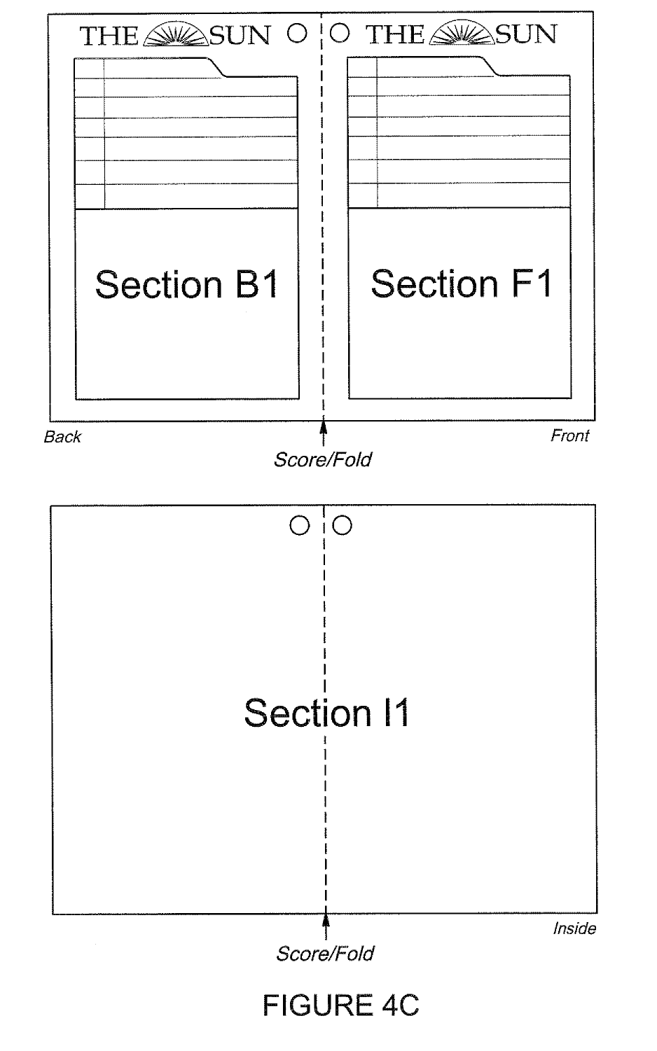

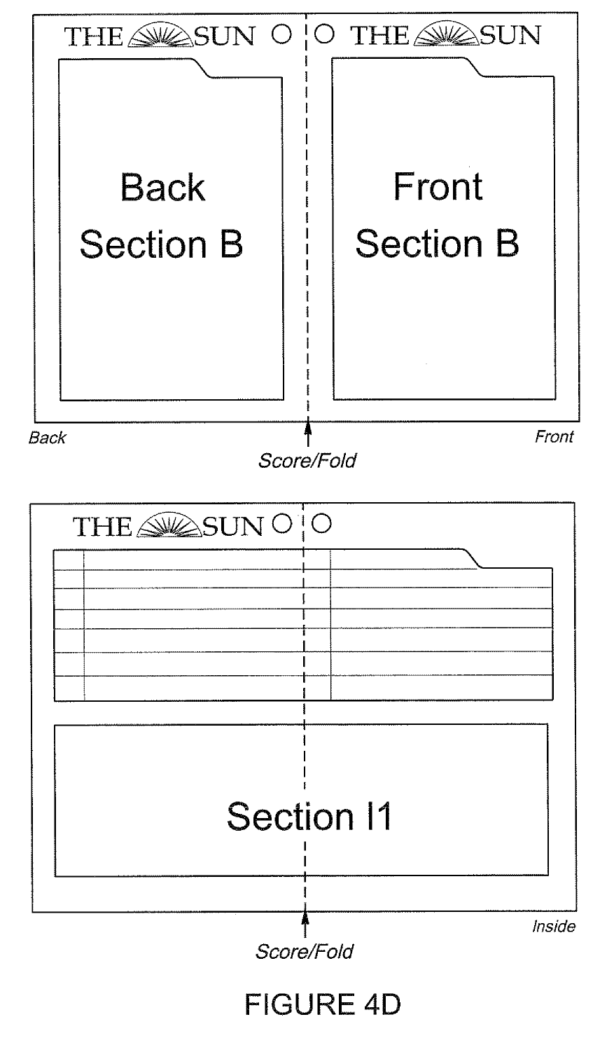

FIGS. 4A-4D illustrates several example schematic layouts of a Tag PABCS layout in accordance with one embodiment of the exemplary illustrative non-limiting implementation. The Tag Shop-n-List includes all of the elements of a printed on a card that is attached to a delivery medium, such as a newspaper by means of an elastic band or tie. In this example embodiment, the entire PABCS is removable from the delivery medium and serves to further the brand using a combination of content, features, and layout.

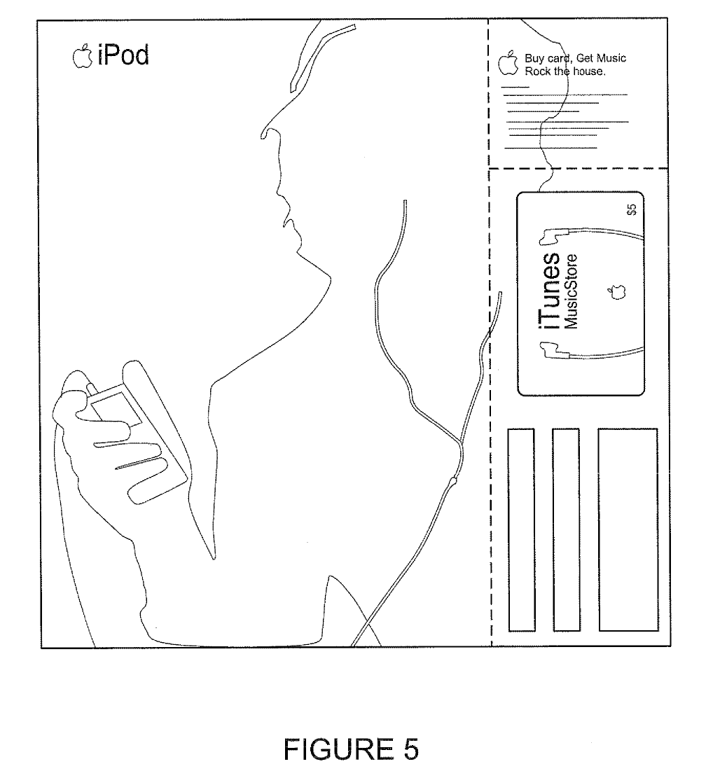

Other alternative embodiments include a “CardSert”, which provides a gift card holder and optional gift card as a functional element. An example embodiment of a CardSert is shown in FIG. 5.

Other illustrative embodiments include a GiftSert, which embodies the design features that incorporate one or more premiums. In one embodiment, a concealed advertiser premium is sealed between two sheets of paper. The user detaches a perforated reader tool (for example, imprinted with some of the features listed above) to reveal and remove the enclosed premium or gift. The premium can include CDs, Gift Cards, product samples, coupon books, game pieces, and so on.

While exemplary illustrative non-limiting implementations have been described in terms of specific embodiments, it is understood that the exemplary illustrative non-limiting implementation can be further modified, used and/or adapted in accordance with the general the principles of the exemplary illustrative non-limiting implementations and including such departures from the present disclosure as come within known or customary practice in the art to which the exemplary illustrative non-limiting implementations pertain, and as can be applied to the essential features set forth. Accordingly, the invention is not to be limited to the disclosed implementations but rather is defined by the claims.

1. An article of manufacture for extending the reach of branding impressions beyond a first delivery medium, comprising:
a first portion, attachable to the delivery medium and comprising one or more branding indicia, effective for conveying the branding, and
a second portion, detachable from the delivery medium, further comprising at least one branding indicia and at least one user functional feature, which are effective to induce the user to detach and use the detachable portion for at least one purpose that is substantially unrelated to the first delivery medium.

2. An article of manufacture of claim 1, further comprising a plurality of functional features on the detachable portion.

3. An article of manufacture of claim 1, further comprising a functional feature of a note grid configured as a shopping list.

4. A device for extending the reach of branding impressions beyond a first delivery medium, comprising:
a first portion, detachable from the delivery medium, comprising one or more branding indicia and at least one user functional features, which are effective to induce the user to detach and use the detachable portion for purposes unrelated to the first delivery medium,
said portion being attached to the delivery medium using one of a tie or band.

5. An article of manufacture comprising:
an item for delivery to a user;
at least one portion that is easily user-detachable from said delivery item, said detachable portion providing a space for a user to write a list and further providing at least one brand indication; and
further means for inducing said user to detach said detachable portion from the delivery item and transport the detachable portion to a point of sale associated with said brand indication.

6. A method of using a PABCS device, comprising the steps of:
A) associating each of a sequence of PABCS devices with at least one of a sequence of periodical publications, and
B) providing the ability for a brand owner to sponsor one or more PABCS devices.
